(19) United States
(12) Patent Application Publication
(10) Pub. No.: US 2009/0184688 A1
(43) Pub. Date: Jul. 23, 2009

(54) CHARGING APPRATUS AND METHOD FOR MOBILE TERMINAL

(75) Inventors: Dae-Kwang KIM, Chilgok-gun (KR); Chul-Ho YUN, Gumi-si (KR); Je-Hyun SON, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/191,495

(22) Filed: Aug. 14, 2008

(30) Foreign Application Priority Data
Sep. 14, 2007 (KR) 2007-93616

(51) Int. Cl. H02J 7/04; H02J 7/00

(52) U.S. Cl. 320/162; 320/137

(57) ABSTRACT

A charging apparatus and method for a mobile terminal are provided. The apparatus and method charge a battery by identifying a charger and operating in an operation mode corresponding to the identified charger. If the mobile terminal is connected to a charger via an outer connector in order to charge the internal power source of the mobile terminal, power and a configuration signal are input from the charger, a logic characteristic is output by using the received configuration signal, and thus the charger can be exactly identified according to the power and the configuration signal. Also, since the internal power source of the mobile terminal is charged through the exactly identified charger, the internal circuit of the mobile terminal or battery can be prevented from being damaged by unstable power of the charger.

### PRIORITY

This application claims the benefit under 35 U.S.C. § 119(a) of a Korean patent application filed with the Korean Intellectual Property Office on Sep. 14, 2007 and assigned Serial No. 2007-0093616, the entire disclosure of which is hereby incorporated by reference.

### BACKGROUND OF THE INVENTION 1. Field of the Invention

The present invention relates to a charging apparatus and method for a mobile terminal. More particularly, the present invention relates to a charging apparatus and method that identifies a charger connected for charging the internal power source of the mobile terminal and operates in an operation mode corresponding to the identified charger.

2. Description of the Related Art

As the technology for mobile terminals has progressed, the market for mobile terminals has extended. More specifically, the progression of mobile terminal technology has allowed mobile terminals to be provided with more functions that are built-in and advanced features.

In particular, a typical mobile terminal is now equipped with a high-performance controller, a high-capacity memory, and a colorful display as standard features. Using these standard features, it is now possible to conveniently store and use a large amount of personal information, and to generate and reproduce various multimedia files.

Accordingly, there is an increasing trend of connecting a mobile terminal to a personal computer in order to perform data communication to better manage the vast information in the mobile terminal.

Another advance in mobile terminal technology is the inclusion of a charging circuit embedded in mobile terminals. The embedded charging circuit, which is provided for general purposes and portable convenience, allows for the battery of a mobile terminal to be charged by simply connecting an external power supply thereto. That is, when an appropriate external power supply is connected to the power source of a mobile terminal, the power source is automatically charged. Thus it is unnecessary for a user to carry a voluminous charging device with him/her.

To this end, a charging method using a Travel Adaptor (TA) is widely used. The TA includes an interface capable of connecting to a communication port (e.g. a universal 24-pin receptacle, etc.) of a mobile terminal, and a means for converting commercial power into charging power. Charging is achieved by connecting the TA between the commercial power and the communication port of a mobile terminal.

FIG. 1 illustrates a conventional structure for connection between a charging cable and a mobile terminal.

As illustrated in FIG. 1, the mobile terminal is connected to a common charger 11 through an outer connector 12.

The charging power pin of the charging cable 11 is connected to the charging input pin of the outer connector 12, and the ground GND of the charging cable 11 is connected to the ground GND of the outer connector 12.

The power supply 13 of the mobile terminal can charge the battery 14 using charging power received through the outer connector 12. Also, the power supply 13 supplies the central processing unit 15 with power.

However, it is inconvenient for the user of the mobile terminal to be required to carry the charger in order to charge the mobile terminal when necessary. Thereupon, there have been developed various charging cables for charging a mobile terminal by using a computer provided in most homes, offices, etc.

In recent years, considering the fact that a period of time during which a mobile terminal communicates with a PC via a Universal Serial Bus (USB) communication cable has been extended, an attempt has been made to utilize power supplied from a USB port for a PC as charging power for a mobile terminal.

FIG. 2 illustrates a conventional structure for connection between a mobile terminal and a USB charging/data cable.

As illustrated in FIG. 2, the mobile terminal is connected to the USB charging/data cable 21 through an outer connector 22.

The charging power pin of the USB charging/data cable 21 is connected to the charging input pin of the outer connector 22, and the ground GND of the USB charging/data cable 21 is connected to the ground GND of the outer connector 22.

Also, for communication with an external computer, terminals USB_D+ and USB_D− of the USB charging/data cable 21 are connected to input terminals D+ and D− of the central processing unit 25 through terminals USB_D+ and USB_D− of the outer connector 22.

The power supply 23 of the mobile terminal can charge the battery 24 by receiving charging power through the outer connector 22, and also supplies the central processing unit 25 with power.

A difference between a common charger and a USB charging/data cable is that the USB charging/data cable enables data exchange as well as charging.

In addition, while a common charger can stably supply a mobile terminal with power at a constant voltage and a constant current, a USB charging/data cable has a problem in that a PC connected to the USB charging/data cable may not supply sufficient charging power depending on the number of devices connected to USB ports and their states.

Furthermore, in order to charge a mobile terminal through a computer, a current must be changed according to the condition of charging power. Also, when the USB supply power of a PC is insufficient, a sudden increase in the charging current supplied to a mobile terminal may cause damage to the internal circuits of both the computer and mobile terminal due to an electric spark or shock.

### SUMMARY OF THE INVENTION

An aspect of the present invention is to address at least the above-mentioned problems and/or disadvantages and to provide at least the advantages described below. Accordingly, an aspect of the present invention is to provide a charging apparatus and method for a mobile terminal, which can identify a charger connected for charging the internal power source of the mobile terminal according to a configuration signal input from the charger, and operate in a mode corresponding to the identified charger to thereby charge the battery of the mobile terminal from the charger.

Further, the present invention provides a charging apparatus and method for a mobile terminal, which can charge an internal power source of the mobile terminal through an identified charger, thereby preventing the internal circuit of the mobile terminal or its battery from being damaged by unstable power of the charger.

In accordance with an aspect of the present invention, a charging apparatus for a mobile terminal is provided. The apparatus includes an outer connector having a voltage bus line, a ground line, and positive and negative data lines through which power and a configuration signal of a charger are respectively input into a mobile terminal, an overvoltage protection unit for preventing an excessive voltage from being input when the mobile terminal is connected to the charger via the outer connector, a charging unit for charging a battery with the power input from the charger and a controller for identifying the charger by the configuration signal of the charger, input through the outer connector, and for controlling the charging unit to operate in an operation mode corresponding to the identified charger and to charge the battery.

In accordance with another aspect of the present invention, a charging method for a mobile terminal is provided. The method includes connecting the mobile terminal to a charger via an outer connector in order to charge an internal power source of the mobile terminal, receiving power and a configuration signal input from the charger, outputting a logic characteristic by using the received configuration signal, identifying the charger by the logic characteristic, and operating in an operation mode corresponding to the identified charger and charging a battery with the power input from the charger according to the operation mode.

In accordance with yet another aspect of the present invention, a charging apparatus for a mobile terminal is provided. The apparatus includes an outer connector having a voltage bus line, a ground line, and positive and negative data lines through which power and a configuration signal of a charger are respectively input into the mobile terminal, a charging unit for receiving the power input through the voltage bus line, and outputting an enable signal, a voltage regulator for converting a range of power into a constant voltage according to the enable signal, and outputting the converted constant voltage; a USB transceiver for outputting the configuration signal of the charger, input through the positive and negative data lines, according to the constant voltage; and a controller for identifying the charger by the configuration signal of the charger, input from the USB transceiver, and controlling the charging unit to operate in an operation mode corresponding to the identified charger and to charge a battery with the power input from the charger.

In accordance with still yet another aspect of the present invention, a charging method for a mobile terminal is provided. The method includes connecting the mobile terminal to a charger via an outer connector in order to charge an internal power source of the mobile terminal, receiving power input from the charger, outputting an enable signal, converting the power into a constant voltage according to the enable signal, identifying the charger by a configuration signal, input through the outer connector, according to the constant voltage, and operating in an operation mode corresponding to the identified charger and charging a battery with the power input from the charger according to the operation mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a view illustrating a conventional structure for connection between a charging cable and a mobile terminal;

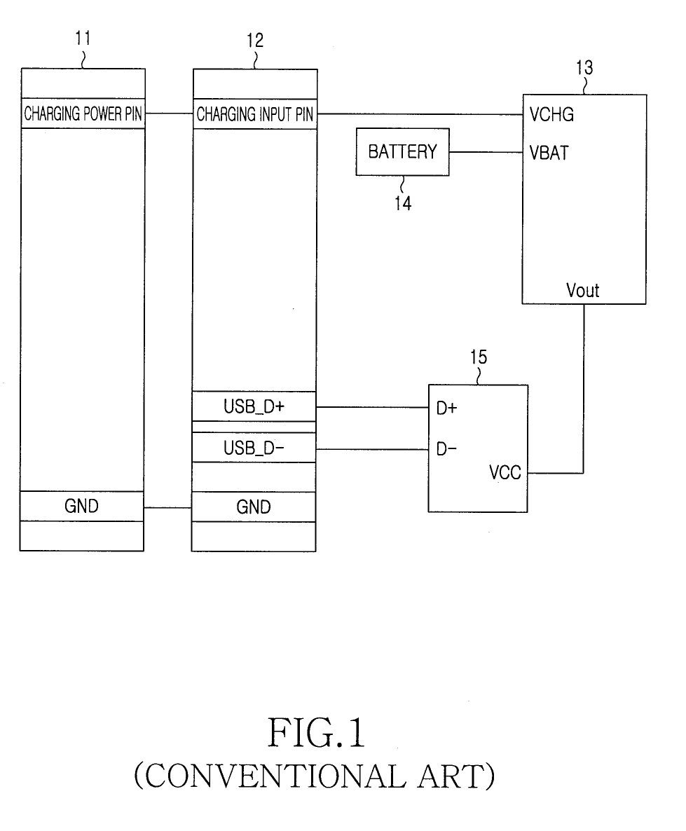

FIG. 2 is a view illustrating a conventional structure for connection between a USB charging/data cable and a mobile terminal;

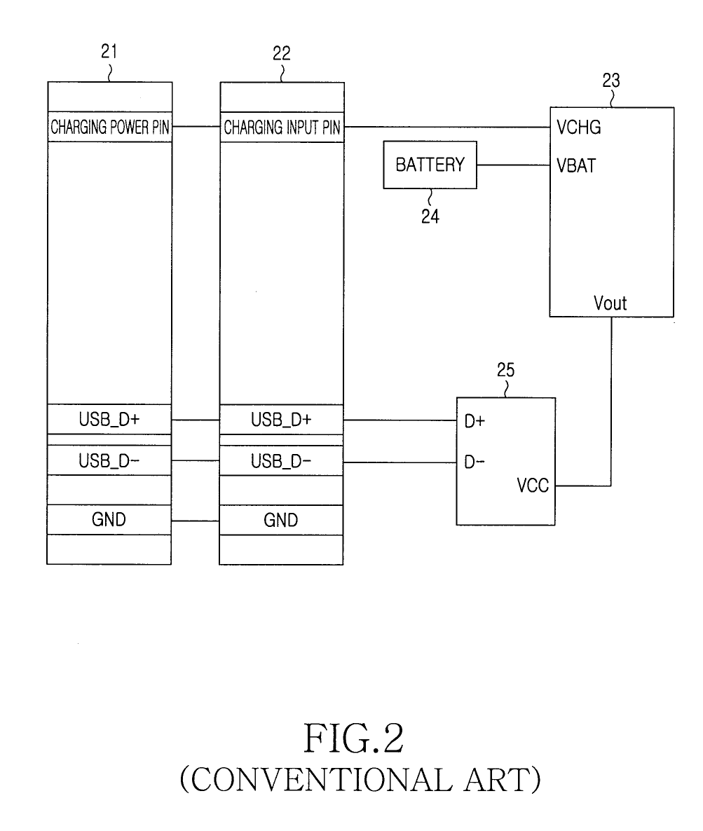

FIG. 3 is a block diagram illustrating a structure of a charging apparatus for a mobile terminal in accordance with an exemplary embodiment of the present invention;

FIG. 4 is a flowchart illustrating a charging method for a mobile terminal in accordance with an exemplary embodiment of the present invention;

FIG. 5 is a block diagram illustrating a structure of a charging apparatus for a mobile terminal in accordance with an exemplary embodiment of the present invention; and

FIG. 6 is a flowchart illustrating a charging method for a mobile terminal in accordance with an exemplary embodiment of the present invention;

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Further, various specific definitions found in the following description are provided to assist with a general understanding of exemplary embodiments of the present invention, and it is apparent to those skilled in the art that the present invention can be implemented without such definitions.

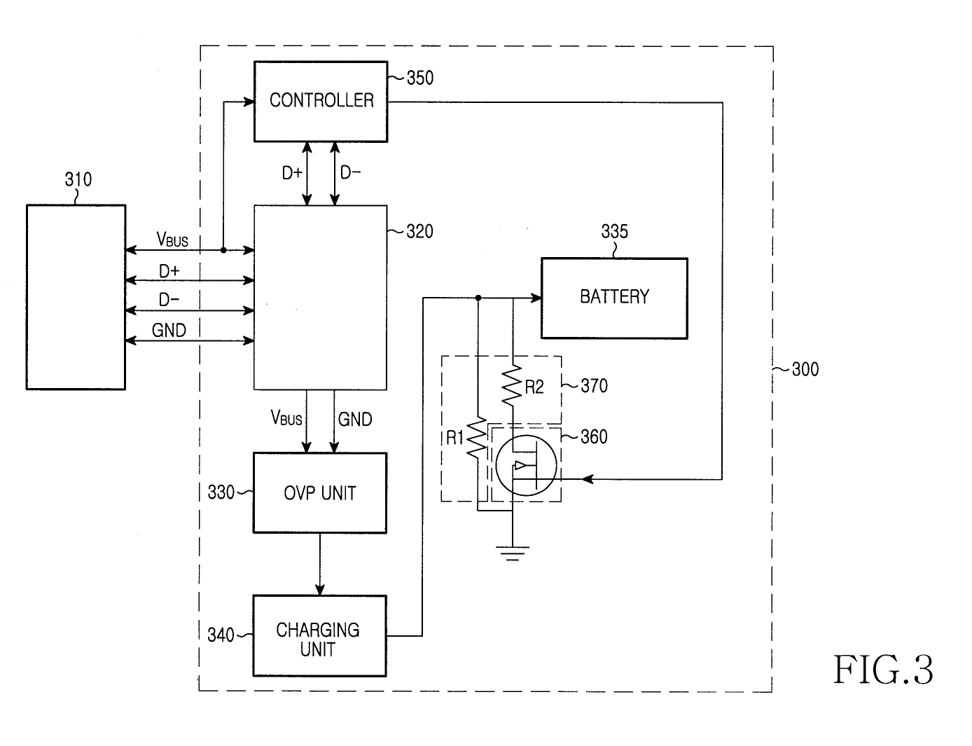

FIG. 3 illustrates a structure of a charging apparatus for a mobile terminal according to an exemplary embodiment of the present invention.

As illustrated in FIG. 3, a mobile terminal 300 is adapted to identify a charger 310 and charge its internal battery 335 with power input from the charger 310 when connected to the charger 310 via an outer connector 320.

The mobile terminal 300 includes the outer connector 320, an OverVoltage Protection (OVP) unit 330, the battery 335, a charging unit 340, a controller 350, a switch 360, and a resistance circuit 370.

The outer connector 320 is connected to the external charger 310 to supply the mobile terminal 300 with power and/or exchange data according to operation modes. Preferably, as described in the Universal Serial Bus Specification, Revision 2.0, the outer connector 320 may be a standard 4-pin USB connector that has a voltage bus (VBus) line, a ground (GND) line, a positive data (D+) line, and a negative data (D−) line.

The VBus line conveys power (e.g. 5V, HIGH) input from the charger 310, and the GND line is connected to the ground potential of the charger 310. Alternatively, the GND line may be connected to any other ground source.

The D+ and D− lines convey a configuration signal input from the charger 310.

Regarding the configuration signal, when the charger 310 corresponds to a notebook computer or a desktop computer, the configuration signal input from the charger 310 swings from signal “HIGH” to signal “LOW” through the D+ line of the outer connector 320, and swings from signal “LOW” to signal “HIGH” through the D− line of the outer connector 320.

Alternatively, when the charger 310 corresponds to a common charger, for example a Travel Adaptor (TA) charger, a configuration signal input from the charger 310 is maintained at signal “HIGH” in both the D+ and D− lines.

The OVP unit 330 prevents excessive power from flowing into the VBus and GND lines of the outer connector 320 when the mobile terminal 300 is connected to the charger 310. For example, the OVP unit provides a protection function by permitting an input voltage of 28V, but interrupting the charging operation in the case of a voltage exceeding an OVP limit by at least 5V.

The charging unit 340 can receive power input from the charger 310 through the OVP unit 330, stabilize the received power, and then charge the battery 335 with the stabilized power. Also, the charging unit 340 supplies the controller 350 with power. The battery 335 may be a rechargeable lithium ion battery or any other type of rechargeable battery. After the charging unit 340 senses the battery 335, it monitors battery defects, charge/discharge characteristics, input voltages, etc., to thereby charge the battery under optimal conditions.

When the mobile terminal 300 is connected to the charger 310, the controller 350 identifies whether the charger 310 is a TA or a USB charger, according to a configuration signal of the charger 310, input through the outer connector 320. Based on the identified charger, the controller 350 controls the charging unit 340 to operate in an operation mode corresponding to the identified charger 310 and charge the battery 335 with power input from the charger 310.

If the mobile terminal 300 is connected to the charger 310 in a power-off state and receives power (e.g. 5V, HIGH) input from the charger 310 through the VBus line of the outer connector 320, the controller 350 controls the charging unit 340 to operate in the USB charging mode and charge the battery 335 with power input from either a USB charger or a TA charger. That is, when the mobile terminal 300 is in a power off state, the controller 350 will operate in a USB charging mode regardless of the type of charger connected to the mobile terminal 300.

The controller 350 includes a logic circuit. If the mobile terminal 300 is connected to the charger 310 in a power-on state, the logic circuit outputs a logic characteristic (i.e. a HIGH or a LOW signal) corresponding to the configuration signal of the charging device, input through the D+ and D− lines.

In an exemplary implementation, the logic circuit is a 2-input 1-output device for allowing the controller 350 to recognize the configuration signal of the charger 310, input through the D+ and D− lines, and consists of an AND gate for outputting a logic value (LOW value or HIGH value) according to binary logic.

TABLE 1

| D+ | D− | output |
|---|---|---|
| LOW | LOW | LOW |
| LOW | HIGH | LOW |
| HIGH | LOW | LOW |
| HIGH | HIGH | HIGH |

Reference will now be made in detail to the AND gate with reference to Table 1 presented above.

If power (e.g. 5V, HIGH) is input from the charger 310 through the VBus line of the outer connector 320, and the AND gate receives a configuration signal that swings from HIGH (LOW) to LOW (HIGH) through the D+ and D− lines, the controller 350 identifies the charger 310 as a USB charger, outputs a corresponding logic characteristic (LOW) signal, and maintains the charging unit 340 in the USB charging mode.

More specifically, the controller 350 outputs the control signal (LOW) to the switch 360 so that the charging unit 340 recognizes a current characteristic I1 through the resistance circuit 370 according to the USB charging mode.

The switch 360 is a device for performing a switching function according to a control signal output from the controller 350. In an exemplary implementation, an N-channel Field Effect Transistor (FET) is used as the switch 360. Of course, the switch may be implemented with another type of switch, for example a P-channel FET, a bipolar device and the like.

The FET switches the resistance circuit 370 in such a manner as to connect the charging unit 340 in series to resistance R1 in the resistance circuit 370 according to the control signal (LOW) output from the controller 350. That is, when the N-channel FET receives the LOW input signal from the controller 350, the FET is in an off state. Accordingly, the resistor R2 is isolated by the FET from the ground connection and is effectively removed from the resistance circuit 370.

The charging unit 340 recognizes a current characteristic I1 through the resistance R1 in the resistance circuit 370, connected in series to the charging unit 340 by the FET. The recognized current characteristic I1 is given by the following equation:

I1=V/R1 (1)

The charging unit 340 charges the battery 335 with power input from the USB charger according to the current characteristic I1 recognized through the resistance R1 in the resistance circuit 370.

Alternatively, if power (5V, HIGH) is input from the charger 310 through the VBus line of the outer connector 320, and the AND gate receives a configuration signal that is maintained at HIGH through both the D+ and D− lines, the controller 350 identifies the charger 310 as a TA, outputs a corresponding logic characteristic (HIGH) signal, and operates the charging unit 340 in the normal charging mode.

The controller 350 outputs a control signal (HIGH) to the switch 360 so that the charging unit 340 recognizes a current characteristic I2 through the resistance circuit 370 according to the normal charging mode.

The switch 360 switches the resistance circuit 370 in such a manner that the charging unit 340 is connected to parallel resistances R1//R2 in the resistance circuit 370 according to the control signal (HIGH) output from the controller 350.

The charging unit 340 recognizes a current characteristic I2 through the resistances R1//R2 in the resistance circuit 370 which are connected in parallel. Specifically, the recognized current characteristic I2 is given by the following equation, where the current characteristic I2 can be adjusted according to values of the resistances R1, R2 in the resistance circuit 370:

I2=V/(R1//R2) (2)

The charging unit 340 charges the battery 335 with power input from the TA according to the current characteristic I2 recognized through the resistances R1//R2 in the resistance circuit 370.

Reference will now be made in detail to the operation of the charging apparatus according to the above exemplary embodiment of the present invention.

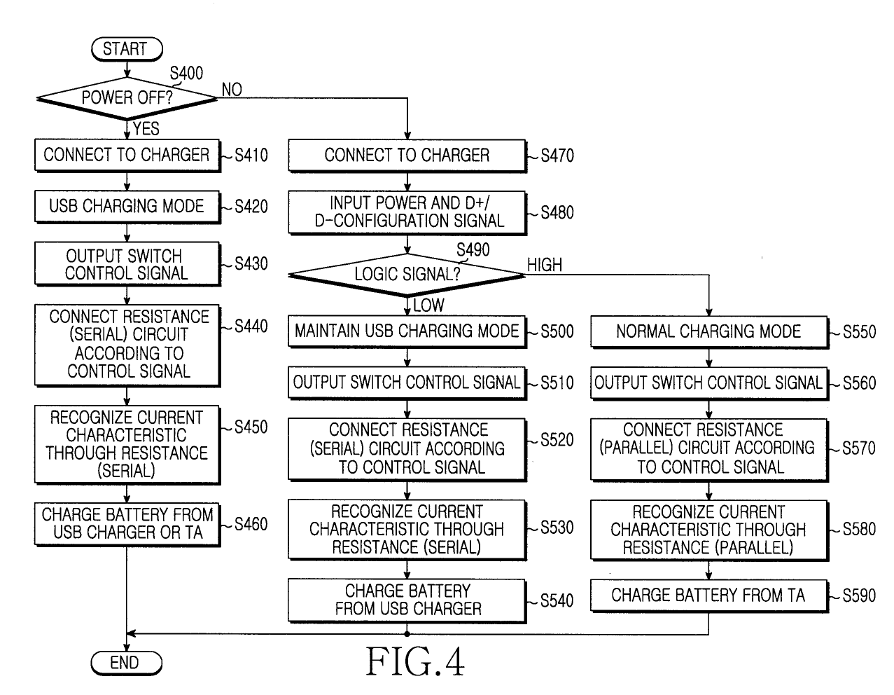

FIG. 4 illustrates a charging method for a mobile terminal according to an exemplary embodiment of the present invention.

Referring to FIG. 4, it is determined in step S400 if power is off to the mobile terminal. If it is determined that the mobile terminal 300 is in a power off state, the mobile terminal proceeds to step S410 where the mobile terminal 300 is connected to the external charger 310. When the mobile terminal 300 is in a power off state and is connected to the external charger 310, the controller 350 operates the charging unit 340 in the USB charging mode in step S420. That is, the mobile terminal 300 receives power (e.g. 5V, HIGH) input from the charger 310 through the VBus line of the outer connector 320.

According to the USB charging mode, the controller 350 outputs a control signal (LOW) to the switch 360 so that the charging unit 340 can recognize a current characteristic I1 through the resistance circuit 370 in step S430.

When the control signal (LOW) is output from the controller 350, the switch 360 switches the resistance circuit 370 in such a manner that the charging unit 340 is connected in series to resistance R1 in the resistance circuit 370 in step S440.

Through the resistance R1 in the resistance circuit 370, connected in series to the charging unit 340 by the switch 360, the charging unit 340 recognizes the current characteristic I1 as given in Equation (1) in step S450.

The charging unit 340 charges the battery 335 using power input from the charger 310, which may be a USB charger or a TA, according to the current characteristic I1 recognized through the resistance R1 in the resistance circuit 370 in step S460.

Alternatively, if it is determined in step S400 that the mobile terminal is in a power on state, the mobile terminal 300 proceeds to step S470 where it is connected to the external charger 310 to receive power (e.g. 5V, HIGH) input from the charger 310 through the VBus line of the outer connector 320. Being connected to the external charger 310, the AND gate receives a configuration signal in step S480. In step S490, the controller 350 determines which type of logic signal to output based on the received configuration signal. In one alternative, the controller receives a configuration signal that swings from HIGH (LOW) to LOW (HIGH) through the D+ (D−) line. As discussed above, such a configuration signal is indicative of a USB connection. Therefore, the controller 350 outputs a corresponding logic characteristic (LOW) signal in step S490 and maintains the charging unit 340 in the USB charging mode in step S500.

The controller 350 outputs the control signal (LOW) to the switch 360 so that the charging unit 340 can recognize a current characteristic I1 through the resistance circuit 370 corresponding to the USB charging mode in step S510.

As the control signal (LOW) is output from the controller 350, the switch 360 switches the resistance circuit 370 in such a manner that the charging unit 340 is connected in series to resistance R1 in the resistance circuit 370 in step S520.

Through the resistance R1 in the resistance circuit 370, connected in series to the charging unit 340, the charging unit 340 recognizes the current characteristic I1 as given in Equation (1) in step S530.

The charging unit 340 charges the battery 335 using power input from the USB charger according to the current characteristic I1 recognized through the resistance R1 in the resistance circuit 370 in step S540.

Referring again to step S490, the AND gate of the controller 350 may receive a configuration signal that is maintained at HIGH through both the D+ and D− lines. As discussed above, this configuration signal corresponds to a TA charger, rather than a USB charger. Accordingly, the controller determines to output a corresponding logic characteristic (HIGH) signal in step S490 and operates the charging unit 340 in the normal charging mode in step S550.

The controller 350 outputs the control signal (HIGH) to the switch 360 so that the charging unit 340 can recognize a current characteristic I2 through the resistance circuit 370 according to the normal charging mode in step S560.

As the control signal (HIGH) is output from the controller 350, the switch 360 switches the resistance circuit 370 in such a manner that the charging unit 340 is connected to parallel resistances R1//R2 in the resistance circuit 370 in step S570.

Through the parallel resistances R1//R2 in the resistance circuit 370, the charging unit 360 recognizes the current characteristic I2 as given in Equation (2) in step S580.

The charging unit 340 charges the battery 335 by receiving power input from the TA charger according to the current characteristic I2 recognized through the resistances R1//R2 in the resistance circuit 370 in step S590.

Although an exemplary embodiment of the present invention has been described as a case where the charging unit 340 is connected to resistances R1 and R2 which are alternatively connected in the resistance circuit 370 to recognize the current characteristics I1 and I2 according to the types of chargers respectively, the current characteristics I1 and I2 may be recognized using resistances R2 and R1 connected in parallel/series to the charging unit 340 respectively.

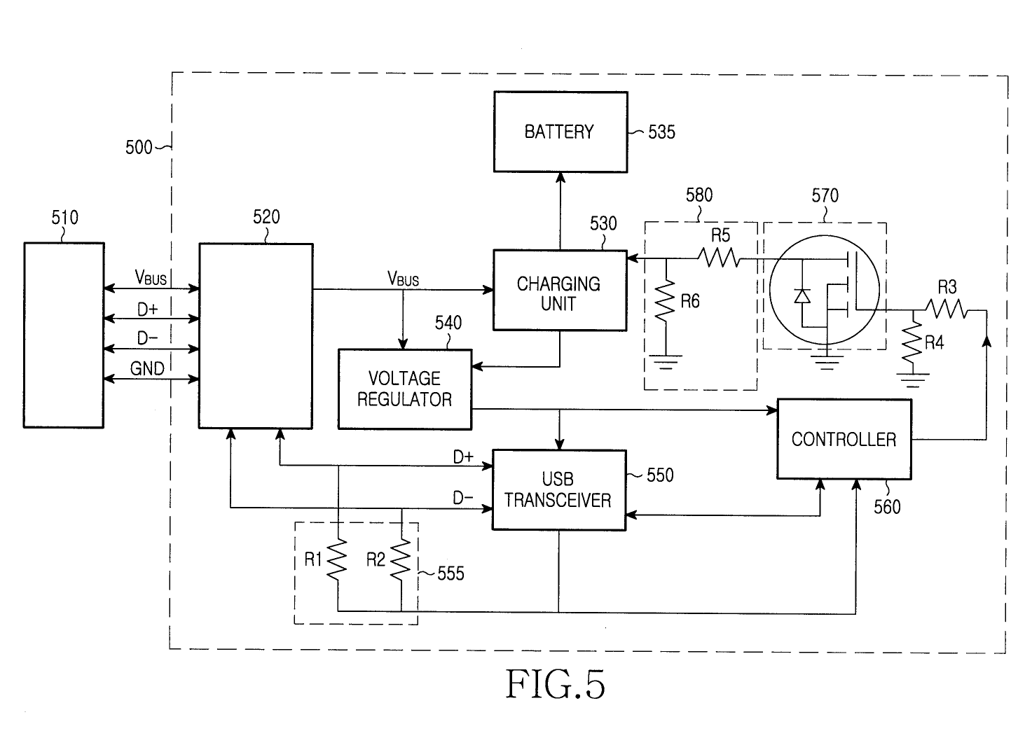

FIG. 5 illustrates a structure of a charging apparatus for a mobile terminal according to an exemplary embodiment of the present invention.

As illustrated in FIG. 5, the mobile terminal 500 is adapted to identify a charger 510 and charge its internal battery 535 with power input from the charger 510 when connected to the charger 510 via an outer connector 520.

The mobile terminal 500 includes the outer connector 520, a charging unit 530, the battery 535, a voltage regulator 540, a USB transceiver 550, a controller 560, a switch 570, and a resistance circuit 580.

The outer connector 520 is connected to the external charger 510 to supply the mobile terminal 500 with power and/or exchange data according to operation modes. Preferably, as described in the Universal Serial Bus Specification, Revision 2.0, the outer connector 520 may be a standard 4-pin USB connector that has a voltage bus (VBus) line, a ground (GND) line, a positive data (D+) line, and a negative data (D−) line.

The VBus line conveys power (e.g. 5V, HIGH) input from the charger 510, and the GND line is connected to the ground potential of the charger 510. Alternatively, the GND line may be connected to any other ground source.

The D+ and D− lines convey a configuration signal input from the charger 510.

With regard to the configuration signal, when the charger 510 corresponds to a notebook computer or a desktop computer, the configuration signal input from the charger 510 swings from signal “HIGH” to signal “LOW” through the D+ line of the outer connector 520, and swings from signal “LOW” to signal “HIGH” through the D− line of the outer connector 520.

Alternatively, when the charger 510 corresponds to a common charger, for example a Travel Adaptor (TA), a configuration signal input from the charger 510 is maintained at signal “HIGH” in both the D+ and D− lines.

When the mobile terminal 500 is connected to the charger 510, the charging unit 530 receives power (e.g. 5V, HIGH) input from the charger 510 through the VBus line, diverged from the outer connector 520, outputs an enable signal to the voltage regulator 540, and charges the battery 535. In an exemplary implementation, an input voltage of −0.3V to 28V is permitted. However, the voltage regulator 540 may regulate the voltage of input power according to an enable signal when the voltage exceeds an OVP limit. The battery 535 may be a rechargeable lithium ion battery or any other type of rechargeable battery. After the charging unit 530 senses the battery 535, it monitors battery defects, charge/discharge characteristics, input voltages, etc., to thereby charge the battery under optimal conditions.

The voltage regulator 540 receives an enable signal input from the charging unit 530, converts a range of received power (e.g. −20V to 38V) into a constant voltage (e.g. 5V, HIGH) in order to prevent the inflow of excessive power when the mobile terminal 500 is connected to the charger 510, and then outputs the converted constant voltage.

The USB transceiver 550 receives the constant voltage (e.g. 5V, HIGH) input from the voltage regulator 540, and outputs a configuration signal of the charger 510, input through the D+ and D− lines, to the controller 560. In an exemplary embodiment, pull-up resistances 555 may be connected between the USB transceiver 550 and the D+ and D− lines in order to maintain the initial state of a configuration signal that swings from signal “HIGH (LOW)” to signal “LOW (HIGH)” through the D+ and D− lines.

For example, pursuant to the USB 1.1 specification, the full-speed transfer rate of a USB is 12 Mbps, and the low-speed transfer rate of a USB is 1.5 Mbps. Also, pursuant to the latest USB 2.0 specification, a data transfer rate is 480 Mbps, which is 40 times as high as the USB 1.1 specification.

Since the USB 2.0 has backward compatibility, the same cable, connector and software as in the USB 1.1 can be used.

The controller 560 includes a logic circuit. If the mobile terminal 500 is connected to the charger 510 in a power-off state, the logic circuit outputs a logic characteristic (HIGH or LOW) by using the constant voltage (e.g. 5V, HIGH) input from the voltage regulator 540. Alternatively, the logic circuit could be included in the USB Transceiver 550 wherein the USB Transceiver 550 would provide a logical output from the logic circuit to the controller 560.

In an exemplary implementation, the logic circuit is a 2-input 1-output device for controlling the charging unit 530 to receive power input from the charger 510 and charge the battery 535. In one exemplary embodiment, the logic circuit consists of an OR gate for outputting a logic value (LOW value or HIGH value) by using binary input information.

TABLE 2

| constant voltage | Y | Output |
|---|---|---|
| LOW | LOW | LOW |
| LOW | HIGH | HIGH |
| HIGH | LOW | HIGH |
| HIGH | HIGH | HIGH |

Here, the state where both the constant voltage and Y are LOW is not used, and Y (HIGH) may be preset.

Reference will now be made in detail to the OR gate with reference to Table 2 presented above.

If the voltage regulator 540 inputs the constant voltage (e.g. 5V, HIGH) into the OR gate, and the OR gate outputs a corresponding logic characteristic (HIGH), the controller 560 controls the charging unit to operate in the USB charging mode and charge the battery 535 by receiving power input from the charger 510 that may be a USB charger or a TA.

If the mobile terminal 500 is connected to the charger 510 in a power-on state, the controller 560 identifies whether the charger 510 is a TA or a USB charger, according to a configuration signal of the charger 510, input from the USB transceiver 550, and controls the charging unit 530 to operate in an operation mode corresponding to the identified charger 510 and charge the battery 535 with power input from the charger 510. That is, software corresponding to the controller 560 identifies between operation modes by using a configuration signal of the charger 510, and charging is selectively performed corresponding to the identified operation mode.

For example, the controller 560 receives a configuration signal of the charger 510, input from the USB transceiver 550 through the D+ and D− lines, and determines whether the received configuration signal is in a normal state or in an abnormal state.

Subsequently, when it is determined that the configuration signal input from the USB transceiver 550 is in a normal state, and a suspend state corresponding thereto is confirmed, the controller 560 identifies the charger 510 as a USB charger, and maintains the charging unit 530 in the USB charging mode.

The controller 560 outputs a control signal (LOW) to the switch 570 so that the charging unit 530 recognizes a current characteristic I3 through the resistance circuit 580 according to the USB charging mode. Also, when it is confirmed that the configuration signal is in an abnormal state, the controller 560 repeatedly checks a configuration signal until a normal state is confirmed.

The switch 570 is a device for performing a switching function according to a control signal (LOW) output from the controller 560. In an exemplary implementation, an N-channel Field Effect Transistor (FET) is used as the switch 360. Of course, other types of switches may also be used. In addition, pull-down resistances R3, R4 may be connected between the switch 570 and the controller 560.

The FET switches the charging unit 530 in such a manner as to be connected in series to resistance R6 in the resistance circuit 580 according to the control signal (LOW) output from the controller 560. That is, when the FET receives a LOW input signal from the controller 560, the FET is in an off position. Accordingly, resistor R5, being isolated from ground, is effectively floating and therefore does not constitute a current path from the charging unit 530 to ground. However, resistor R6 is connected between the charging unit 530 and ground without an intervening switch.

The charging unit 530 recognizes a current characteristic I3 through the resistance R6 in the resistance circuit 580, connected in series to the charging unit 530, and the recognized current characteristic I3 is given by the following equation:

I3=V/R6 (3)

The charging unit 530 charges the battery 535 with power input from the USB charger according to the current characteristic I3 recognized through the resistance R6 in the resistance circuit 580.

If it is confirmed that a configuration signal of the charger 510, input from the USB transceiver 550, is in a normal state, but still a suspend state corresponding thereto is not confirmed, the controller 560 identifies the charger 510 as a TA, and operates the charging unit 530 in the normal charging mode.

The controller 560 outputs a control signal (HIGH) to the switch 570 so that the charging unit 530 recognizes a current characteristic I4 through the resistance circuit 580 according to the normal charging mode.

The switch 570 switches the resistance circuit 580 in such a manner that the charging unit 530 is connected to parallel resistances R5//R6 in the resistance circuit 580 according to the control signal (HIGH) output from the controller 560.

The charging unit 530 recognizes a current characteristic I4 through the resistances R5//R6 in the resistance circuit 580, connected in parallel by the switch 570, and the recognized current characteristic I4 is given by the following equation, where the current characteristic I4 can be adjusted according to values of the resistances R5, R6 in the resistance circuit 580:

I4=V/(R5//R6) (4)

The charging unit 530 charges the battery 535 with power input from the TA according to the current characteristic I4 recognized through the resistances R5//R6 in the resistance circuit 580.

Reference will now be made in detail to an operation of the charging apparatus according to the above exemplary embodiment of the present invention.

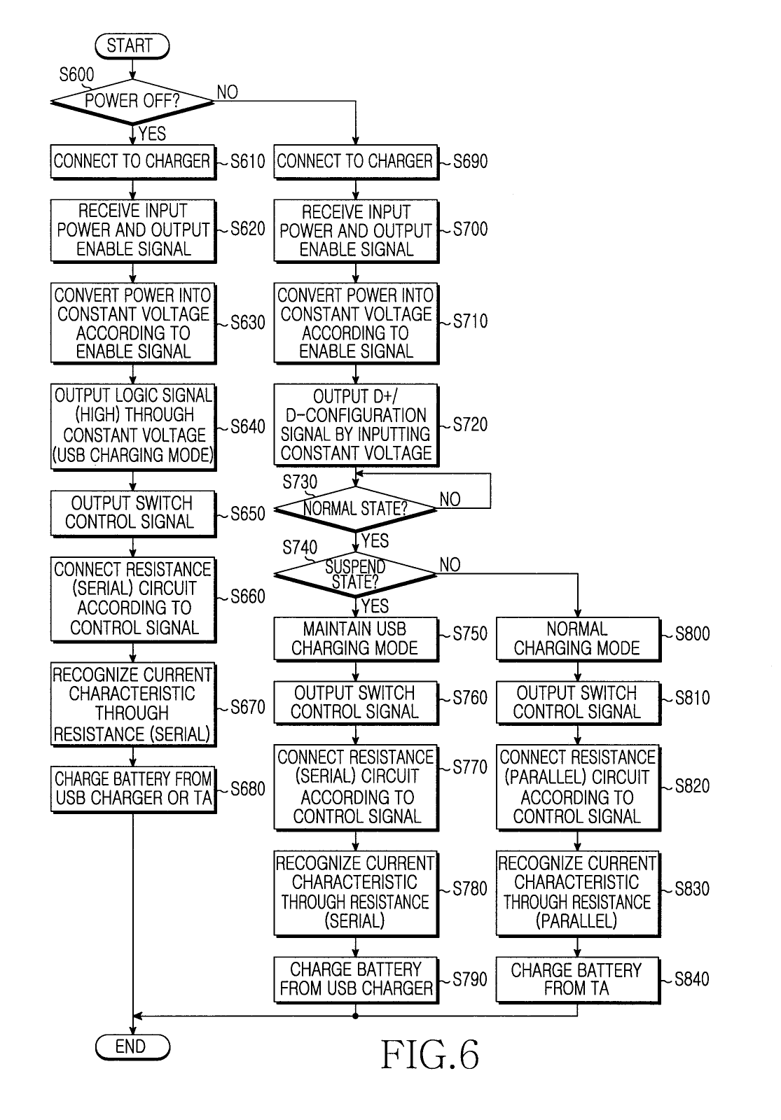

FIG. 6 illustrates a charging method for a mobile terminal according to an exemplary embodiment of the present invention.

Referring to FIG. 6, it is determined in step S600 if power is off to the mobile terminal 500. If it is determined that the mobile terminal 500 is in a power off state, the mobile terminal proceeds to step S610 where the mobile terminal 500 is connected to the external charger 510. When the mobile terminal 500 is in a power-off state and is connected to the external charger 510, the charging unit 530 receives power input from the charger 510 through the VBus line diverged from the outer connector 520, and outputs an enable signal to the voltage regulator 540 in step S620.

On receiving the enable signal input from the charging unit 530, the voltage regulator 540 converts power into a constant voltage (5V, HIGH), and outputs the converted constant voltage in step S630.

On receiving the constant voltage (5V, HIGH) input from the voltage regulator 540, the logic circuit outputs a corresponding logic characteristic (HIGH) to thereby operate the charging unit 530 in the USB charging mode in step S640.

Subsequently, the controller 560 outputs a control signal (LOW) to the switch 570 so that the charging unit 530 can recognize a current characteristic I3 through the resistance circuit 580 according to the USB charging mode in step S650.

As the control signal (LOW) is output from the controller 560, the switch 570 switches the charging unit 530 in such a manner as to be connected to resistance R6 in the resistance circuit 580 in step S660.

Through the resistance R6 in the resistance circuit 580, the charging unit 530 recognizes the current characteristic I3 as given in Equation (3) in step S670.

The charging unit 530 charges the battery 535 by receiving power input from the charger 510, which may be a USB charger or a TA, according to the current characteristic I3 recognized through the resistance R5 in the resistance circuit 580 in step S680.

Referring again to step S600, if it is determined that the mobile terminal 500 is in a power on state, and the mobile terminal 500 is connected to the external charger 510 in step S690, the charging unit 530 receives power input from the charger 510 through the VBus line diverged from the outer connector 520, and outputs an enable signal to the voltage regulator 540 in step S700.

On receiving the enable signal input from the charging unit 530, the voltage regulator 540 converts power into a constant voltage (5V, HIGH), and outputs the converted constant voltage in step S710.

On receiving the constant voltage (5V, HIGH) input from the voltage regulator 540, the USB transceiver 550 outputs a configuration signal of the charger 510 in step S720.

On receiving the configuration signal of the charger 510, input from the USB transceiver 550, the controller determines whether the received configuration signal is in a normal state or in an abnormal state in step S730.

When it is confirmed that the configuration signal input from the USB transceiver 550 is in a normal state, and a suspend state corresponding thereto is confirmed in step S740, the controller 560 identifies the charger 510 as a USB charger, and maintains the charging unit 530 in the USB charging mode in step S750.

Subsequently, the controller 560 outputs a control signal (LOW) to the switch 570 so that the charging unit 530 recognizes a current characteristic I3 through the resistance circuit 580 according to the USB charging mode in step S760.

Referring again to step S730, when it is confirmed that the configuration signal is in an abnormal state, the controller 560 repeatedly checks a configuration signal until a normal state is confirmed.

As the control signal (LOW) is output from the controller 560, the switch 570 switches the charging unit 530 in such a manner as to be connected to resistance R6 in the resistance circuit 580 in step S770.

Through the resistance R6 in the resistance circuit 580, the charging unit 530 recognizes the current characteristic I3 as given in Equation (3) in step S780.

The charging unit 530 charges the battery 535 by receiving power input from the USB charger according to the current characteristic I3 recognized through the resistance R6 in the resistance circuit 580 in step S790.

However, if it is determined in step S730 that the configuration signal of the charger 510, input from the USB transceiver 550, is in a normal state, but still a suspend state corresponding thereto is not confirmed in step S740, the controller 560 identifies the charger 510 as a TA, and operates the charging unit 530 in the normal charging mode in step S800.

Subsequently, the controller 560 outputs a control signal (HIGH) to the switch 570 so that the charging unit 530 recognizes a current characteristic I4 through the resistance circuit 580 according to the normal charging mode in step S810.

As the control signal (HIGH) is output from the controller 560, the switch 570 switches the resistance circuit 580 in such a manner as to connect the charging unit 530 to parallel resistances R5//R6 in the resistance circuit 580 in step S820.

Through the resistances R5//R6 in the resistance circuit 580, connected in parallel to the charging unit 530 by the switch 570, the charging unit 530 recognizes the current characteristic I4 as given in Equation (4) in step S830.

The charging unit 530 charges the battery 535 by receiving power input from the TA according to the current characteristic I4 recognized through the resistances R5//R6 in the resistance circuit 580 in step S840.

Although an exemplary embodiment of the present invention has been described with a case where the charging unit 530 is connected in series/parallel to resistances R5 and R6 in the resistance circuit 580 to recognize current characteristics I3 and I4 according to the types of chargers respectively, the current characteristics I3 and I4 may be recognized using resistances R6 and R5 connected in parallel/series to the charging unit 530 respectively.

According to exemplary embodiments of the present invention as described above, a logic characteristic is output using a configuration signal of a charger connected for charging the internal power source of a mobile terminal, so that the charger can be exactly identified according to power and the logic characteristic.

Also, since the internal power source of the mobile terminal is charged through the identified charger, the internal circuit of the mobile terminal or battery can be prevented from being damaged by unstable power of the charger.

While a charging apparatus and method for a mobile terminal according to exemplary embodiments of the present invention may be implemented, and the present invention has been shown and described with reference to certain exemplary embodiments thereof, it will be understood by those skilled in the art that various changes in form and details may be made therein without departing from the spirit and scope of the invention as defined by the appended claims and their equivalents. Accordingly, the scope of the invention is not to be limited by the above embodiments but by the appended claims and equivalents thereof.

What is claimed is:

1. A charging apparatus for a mobile terminal, the apparatus comprising:
an outer connector having a voltage bus line, a ground line, and positive and negative data lines through which power and a configuration signal of a charger are respectively input into a mobile terminal;
an overvoltage protection unit for preventing an excessive voltage from being input when the mobile terminal is connected to the charger via the outer connector;
a charging unit for charging a battery with the power input from the charger; and
a controller for identifying the charger by the configuration signal of the charger, input through the outer connector, and for controlling the charging unit to operate in an operation mode corresponding to the identified charger and to charge the battery.

2. The apparatus of claim 1, further comprising:
a resistance circuit including serial resistance and parallel resistance for allowing the charging unit to recognize a current characteristic according to the operation mode; and
a switch for selectively switching the serial resistance and the parallel resistance according to a control signal input from the controller.

3. The apparatus of claim 1, wherein if the power is input through the voltage bus line in a power-off state of the mobile terminal, the controller controls the charging unit to operate in a USB charging mode and to charge the battery with the power input from at least one of a USB charger and a travel adapter.

4. The apparatus of claim 2, wherein the controller includes a logic circuit for outputting a logic characteristic by using the configuration signal of the charger, input through the positive and negative data lines in a power-on state of the mobile terminal.

5. The apparatus of claim 4, wherein if the power is input from the charger through the voltage bus line, and the logic circuit receives the configuration signal of the charger, which swings from at least one of signal HIGH to signal LOW and signal LOW to signal HIGH, the controller identifies the charger as a USB charger and maintains a USB charging mode.

6. The apparatus of claim 5, wherein the controller outputs the control signal to the switch such that the switch connects the serial resistance to the charging unit according to the USB charging mode.

7. The apparatus of claim 6, wherein the charging unit charges the battery from the USB charger by recognizing the current characteristic through the serial resistance connected thereto by the switch.

8. The apparatus of claim 4, wherein if the power is input from the charger through the voltage bus line, and the logic circuit receives the configuration signal of the charger, which is maintained at signal HIGH in both the data lines, the controller identifies the charger as a travel adapter and operates the charging unit in a normal charging mode.

9. The apparatus of claim 8, wherein the controller outputs the control signal to the switch such that the switch connects the parallel resistance to the charging unit according to the normal charging mode.

10. The apparatus of claim 9, wherein the charging unit charges the battery from the travel adapter by recognizing the current characteristic through the parallel resistance connected thereto by the switch.

11. A charging method for a mobile terminal, the method comprising:
connecting the mobile terminal to a charger via an outer connector in order to charge an internal power source of the mobile terminal;
receiving power and a configuration signal input from the charger;
outputting a logic characteristic by using the received configuration signal;
identifying the charger by the logic characteristic, and operating in an operation mode corresponding to the identified charger; and
charging a battery with the power input from the charger according to the operation mode.

12. The method of claim 11, wherein the charging of the battery comprises:
if the power is input through the voltage bus line in a power-off state of the mobile terminal, operating in a USB charging mode; and
charging the battery with the power input from at least one of a USB charger and a travel adapter.

13. The method of claim 11, wherein the operating in the operation mode corresponding to the identified charger comprises:
receiving the power input through a voltage bus line of the outer connector by being connected to the charger in a power-on state of the mobile terminal; and
if the configuration signal of the charger, which swings from at least one of signal HIGH to signal LOW and signal LOW to signal HIGH through positive and negative data lines of the outer connector, is input, and the logic characteristic corresponding thereto is output, identifying the charger as a USB charger, and maintaining a USB charging mode.

14. The method of claim 13, wherein the maintaining of the USB charging mode further comprises outputting a control signal to a switch such that the switch connects serial resistance in a resistance circuit to a charging unit according to the USB charging mode.

15. The method of claim 14, wherein the outputting of the control signal further comprises controlling the charging unit to charge the battery from the USB charger by recognizing a current characteristic through the serial resistance connected thereto by the switch.

16. The method of claim 11, wherein the operating in the operation mode corresponding to the identified charger comprises:
receiving the power input through a voltage bus line of the outer connector by being connected to the charger in a power-on state of the mobile terminal; and
if the configuration signal of the charger, which is maintained at signal HIGH through both positive and negative data lines of the outer connector, is input, and the logic characteristic corresponding thereto is output, identifying the charger as a travel adapter, and operating in a normal charging mode.

17. The method of claim 16, wherein the operating in the normal charging mode further comprises outputting a control signal to a switch such that the switch connects parallel resistance in a resistance circuit to a charging unit according to the normal charging mode.

18. The method of claim 17, wherein the outputting of the control signal further comprises controlling the charging unit to charge the battery from the travel adapter by recognizing a current characteristic through the parallel resistance connected thereto by the switch.

19. A charging apparatus for a mobile terminal, the apparatus comprising:
an outer connector having a voltage bus line, a ground line, and positive and negative data lines through which power and a configuration signal of a charger are respectively input into a mobile terminal;
a charging unit for receiving the power input through the voltage bus line and outputting an enable signal;
a voltage regulator for converting a range of power into a constant voltage according to the enable signal, and outputting the converted constant voltage;
a USB transceiver for outputting the configuration signal of the charger, input through the positive and negative data lines, according to the constant voltage; and
a controller for identifying the charger by the configuration signal of the charger, input from the USB transceiver, and controlling the charging unit to operate in an operation mode corresponding to the identified charger and charge a battery with the power input from the charger.

20. The apparatus of claim 19, further comprising:
a resistance circuit including serial resistance and parallel resistance for allowing the charging unit to recognize a current characteristic according to the operation mode; and
a switch for selectively switching the serial resistance and the parallel resistance according to a control signal input from the controller.

21. The apparatus of claim 19, wherein the controller includes a logic circuit for outputting a logic characteristic by using the constant voltage, input from the voltage regulator, in a power-off state of the mobile terminal.

22. The apparatus of claim 21, wherein the controller controls the charging unit to operate in a USB charging mode according to the logic characteristic output form the logic circuit and to charge the battery with the power input from at least one of a USB charger and a travel adapter.

23. The apparatus of claim 20, wherein the controller receives the configuration signal of the charger, input from the USB transceiver, to determine whether the configuration signal is in a normal state or in an abnormal state, and if the configuration signal is confirmed to be in the normal state and a suspend state corresponding thereto is confirmed, identifies the charger as a USB charger, and maintains a USB charging mode.

24. The apparatus of claim 23, wherein the controller outputs the control signal to the switch such that the switch connects the serial resistance to the charging unit according to the USB charging mode.

25. The apparatus of claim 24, wherein the charging unit charges the battery from the USB charger by recognizing the current characteristic through the serial resistance connected thereto by the switch.

26. The apparatus of claim 23, wherein if the configuration signal of the charger, input from the USB transceiver, is confirmed to be in the normal state, and the suspend state corresponding thereto is not confirmed, the controller identifies the charger as a travel adapter, and operates the charging unit in a normal charging mode.

27. The apparatus of claim 26, wherein the controller outputs the control signal to the switch such that the switch connects the parallel resistance to the charging unit according to the normal charging mode.

28. The apparatus of claim 27, wherein the charging unit charges the battery from the travel adapter by recognizing the current characteristic through the parallel resistance connected thereto by the switch.

29. A charging method for a mobile terminal, the method comprising:
connecting the mobile terminal to a charger via an outer connector in order to charge an internal power source of the mobile terminal;
receiving power input from the charger;
outputting an enable signal;
converting the power into a constant voltage according to the enable signal;
identifying the charger by a configuration signal, input through the outer connector, according to the constant voltage, and operating in an operation mode corresponding to the identified charger; and
charging a battery with the power input from the charger according to the operation mode.

30. The method of claim 29, wherein the charging of the battery comprises:
if the mobile terminal is connected to the charger in a power-off state thereof, outputting a logic characteristic by using the constant voltage;
operating in a USB charging mode according to the logic characteristic; and
charging the battery with the power input from at least one of a USB charger and a travel adapter according to the USB charging mode.

31. The method of claim 29, wherein the operating in the operation mode corresponding to the identified charger comprises:
receiving the configuration signal of the charger, and determining whether the configuration signal is in a normal state or in an abnormal state; and
if the configuration signal of the charger, input from a USB transceiver, is in the normal state, and a suspend state corresponding thereto is confirmed, identifying the charger as a USB charger, and maintaining a USB charging mode.

32. The method of claim 31, wherein the maintaining of the USB charging mode further comprises outputting a control signal to a switch such that the switch connects serial resistance in a resistance circuit to a charging unit according to the USB charging mode.

33. The method of claim 32, wherein the outputting of the control signal further comprises controlling the charging unit to charge the battery from the USB charger by recognizing a current characteristic through the serial resistance connected thereto by the switch.

34. The method of claim 31, wherein when the configuration signal is in the abnormal state, the determining of the configuration signal is repeatedly performed until it is confirmed that the configuration signal is in the normal state.

35. The method of claim 31, wherein the determining of the configuration signal comprises, if the configuration signal of the charger is confirmed to be in the normal state, and the suspend state corresponding thereto is not confirmed, identifying the charger as a travel adapter, and operating in a normal charging mode.

36. The method of claim 35, wherein the operating in the normal charging mode further comprises outputting a control signal to a switch such that the switch connects parallel resistance in a resistance circuit to a charging unit according to the normal charging mode.

37. The method of claim 36, wherein the outputting of the control signal further comprises controlling the charging unit to charge the battery from the travel adapter by recognizing a current characteristic through the parallel resistance connected thereto by the switch.
